(19) United States
(12) Patent Application Publication
(10) Pub. No.: US 2006/0065224 A1
(43) Pub. Date: Mar. 30, 2006

(54) COMBUSTION ENGINE PULL-CORD START SYSTEM

(75) Inventor: George M. Pattullo, Caro, MI (US)

Correspondence Address: REISING, ETHINGTON, BARNES, KISSELLE, P.C., P O BOX 4390, TROY, MI, 48099-4390, US

(73) Assignee: Walbro Engine Management, L.L.C.

(21) Appl. No.: 10/951,149

(22) Filed: Sep. 27, 2004

(51) Int. Cl. F02M 1/02; F01L 13/08; F02N 1/00

(52) U.S. Cl. 123/179.18; 123/182.1; 123/185.3

(57) ABSTRACT

A manual pull-cord start system of a combustion engine has a remote start assist device such as a choke of a carburetor or a compression relief valve that is automatically actuated upon the initial pull of a pull-cord of a recoil starter assembly. The assembly has a releasable coupling which intermittently engages a recoil pulley of the recoil starter assembly about which the cord is wound. Upon the initial pull of the cord, a shuttle of the coupling moves generally with the pulley, to move a linkage connected to actuate the external start assist device. Upon release of the cord, the shuttle and the remote start assist device automatically return to their normal state during engine operation.

### FIELD OF THE INVENTION

The present invention relates generally to a combustion engine start system and more particularly to a pull-cord start system for automatic actuation of a carburetor or other starting device.

### BACKGROUND OF THE INVENTION

Small internal combustion engines which are typically utilized for recreational vehicles and garden implement applications such as chain saws, tractors and lawn mowers have pull-cord type start systems. The operator of the garden tool or vehicle must manually pull a retractable cord attached to a recoil pulley which rotates a crank shaft for starting of the combustion engine. The cord automatically retracts when released by the user about the pulley which is connected to a torsional coil spring device.

In a conventional recoil starter mechanism, pulling the cord rotates the recoil pulley which through a one way clutch or coupling rotates the crankshaft to start the engine. In a so called spring starter mechanism, pulling the cord rotates the recoil pulley which winds up a torsion spring which when released unwinds to rotate, through a one way clutch or coupling, the crankshaft to start the engine. In both the recoil and spring starter mechanisms, the one way clutch or coupling allows the crankshaft of the running engine to rotate freely relative to the recoil pulley.

Unfortunately, when the cold engine is initially started the user must first remember to manually close the choke valve to deliver a rich mixture of fuel-and-air to the engine when the cord is pulled. Moreover, and if the engine was shut down with the exhaust and intake valves closed (i.e. compression stroke of the engine), pulling of the cord is difficult and may actually snap back into the pulley housing because the trapped air within the combustion chamber resists compression essentially locking the piston and crankshaft in their arbitrarily shutdown position.

### SUMMARY OF THE INVENTION

A pull-cord start system of a combustion engine has a remote start assist device that is automatically actuated upon the initial pull of a pull-cord of a recoil starter assembly. The assembly has a releasable coupling which intermittently engages a recoil pulley of the recoil starter assembly about which the cord is wound. Upon the initial pull of the cord, a shuttle of the coupling moves generally with the pulley, pulling upon a linkage constructed and arranged to actuate the external start device. Upon release of the cord, the shuttle and the remote start assist device automatically re-align themselves.

Preferably, the releasable coupling has a roller engaged rotatably to the shuttle and disposed radially outward from the pulley. A winding of a plurality of windings of the cord is wound or encompasses both the pulley and the roller with the remaining windings being either wound about just the pulley and/or withdrawn from a housing of the recoil starter assembly which generally houses both the pulley and the shuttle.

Preferably the start assist device is a carburetor having a choke valve operatively associated with a throttle valve. Upon initial pulling of the cord of the recoil starter assembly, movement of the releasable coupling pulls upon a linkage, which closes the choke valve and partially opens the throttle valve. Upon release of the cord, the pulley automatically recoils the cord and the releasable coupling moves back, thus negating the pulling force upon the linkage which allows the yieldably biased open choke valve to partially open to an engine warm-up position while the throttle valve remains in a partially open position until the operator actuates a throttle pedal or trigger to increase engine speed.

Objects, features and advantages of his invention include a reliable starting engine having a simplified start-up procedure, elimination of pull-cord kickback, and elimination of the engine stalling on an overly rich mixture of fuel-and-air. Moreover, the pull-cord start system is compact in construction, relatively simple in design, of low cost when mass produced, and is rugged, durable, reliable, requires little maintenance and no adjustment in use, and in service has a long useful life.

### BRIEF DESCRIPTION OF THE DRAWINGS

These and other objects, features and advantages of this invention will be apparent from the following detailed description, appended claims, and accompanying drawings in which:

FIG. 1 is a combined partial section view of a recoil starter assembly of a pull-cord start system of the present invention illustrated in an unwound state; and a side view of a carburetor of the pull-cord start system linked to the starter assembly and illustrated in a closed position with a throttle valve substantially open;

FIG. 2 is a section view of the pull-cord start system illustrated in a recoiling state with the carburetor illustrated in an engine warm-up orientation;

FIG. 3 is a section view of the pull-cord start system illustrated in a recoiled state and wherein the choke valve is illustrated in the engine warm-up orientation;

FIG. 4 is a section view of the carburetor of the pull-cord start system with the throttle valve at idle and the choke valve fully open;

FIG. 5 is a section view of the carburetor of the pull-cord start system illustrating the throttle valve opening from the idle position and the choke valve closing from the open position to a partially closed position when the cord is pulled from the released state;

FIG. 6 is a partial section view of the pull-cord start system taken along line 6-6 of FIG. 1;

FIG. 7 is a partial section view of a first modification of a pull-cord start system;

FIG. 8 is a partial section view of a second modification of a pull-cord start system;

FIG. 9 is a section view of a third modification of a pull-cord start system; and

FIG. 10 is a section view of a fourth modification of a pull-cord start system.

### DETAILED DESCRIPTION OF THE PREFERRED EMBODIMENTS

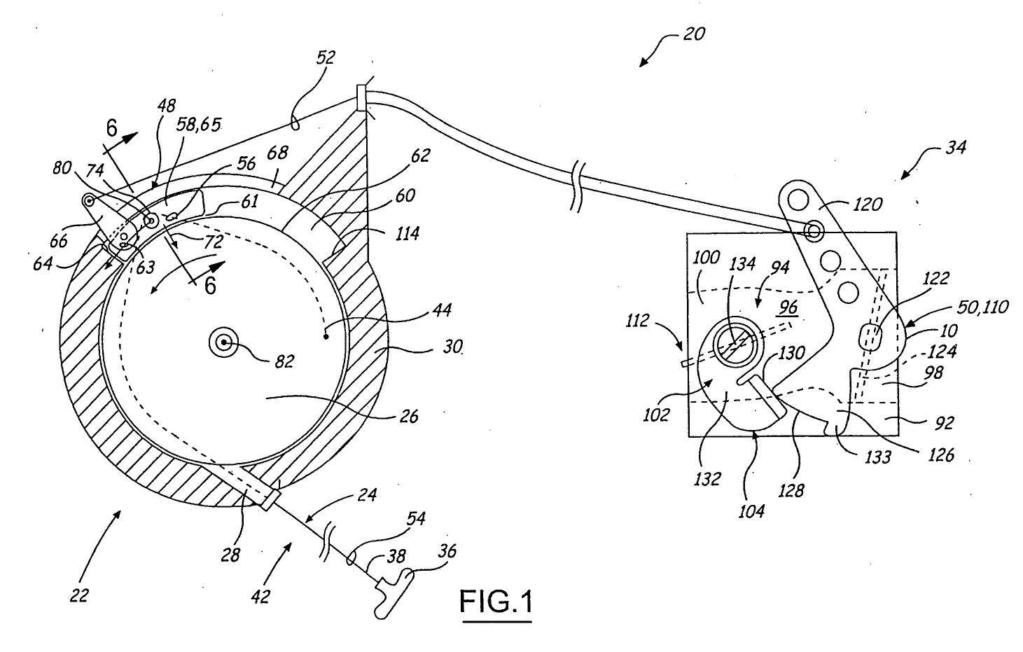

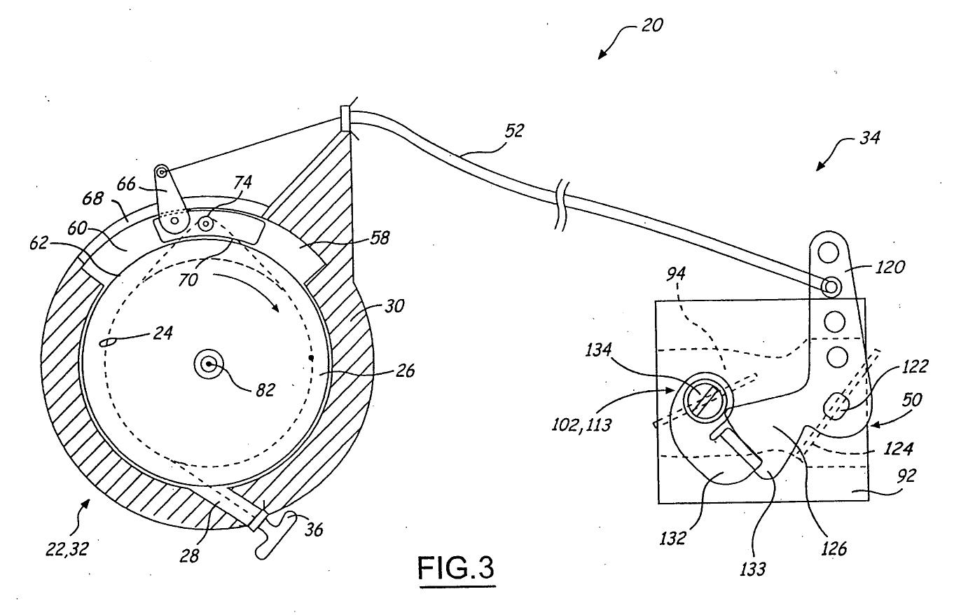

Referring in more detail to the drawings, FIGS. 1-3 illustrate a pull-cord start system 20 of the present invention preferably utilized on small displacement internal combustion engines which commonly require a manual pull-cord recoil starter assembly 22 for starting the engine. When a pull-cord 24 of the recoil starter assembly 22 is pulled by an operator against a rotational bias of a pulley or spindle 26 through a cord conduit 28 carried by a housing 30 of the assembly 22, a crank shaft of the engine is rotated at a speed sufficient to start the engine. The pulley 26 is connected by a one way clutch or coupling to drive the crankshaft as the cord is pulled and to permit the crankshaft to freely rotate relative to the pulley when the engine is running. During initial unwinding of the cord 24 from a recoiled state 32 (as best shown in FIG. 3), the pull-cord start system 20 not only begins to rotate the crankshaft, but also actuates an external start assist device 34 which may include, but is not limited to, a carburetor as illustrated in FIGS. 1-3 and 4-5, and/or a combustion chamber pressure relief valve as illustrated in FIG. 10.

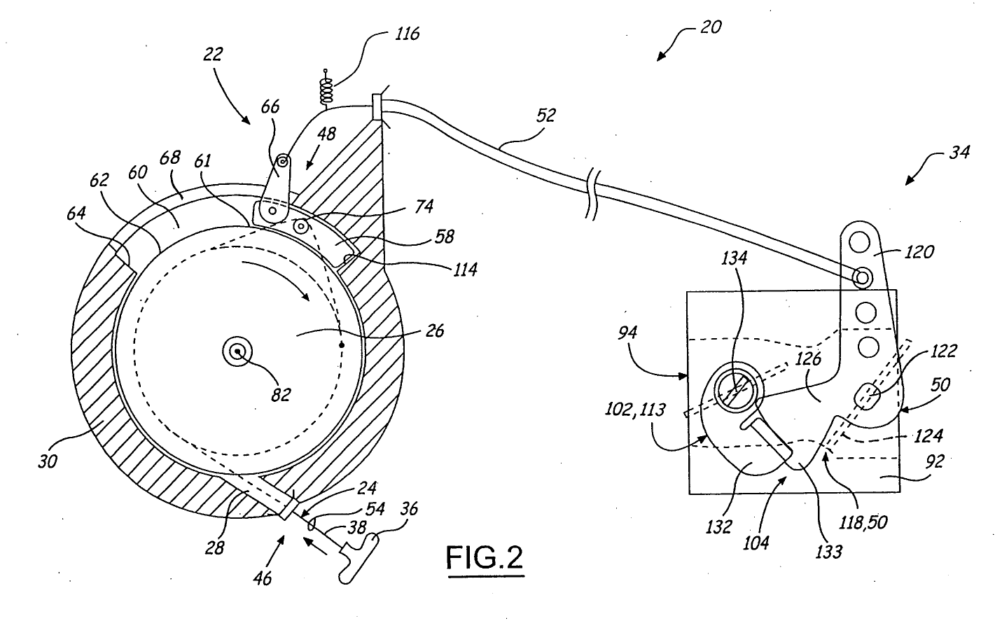

When starting the engine, the operator manually grasps a handle 36 attached to a first distal end 38 of the cord 24 and pulls the cord 24 outward from the housing 30 which turns the pulley 26 in a counter-clockwise direction (as viewed in FIG. 1) against the bias of a torsional spring (not shown) generally engaged between the pulley 26 and the housing 30. The operator must pull the cord with sufficient strength to overcome the bias of the pulley recoil spring which would otherwise cause the cord 24 to rewind back into the housing 30 within a circumferential groove 40 carried by the pulley 26 and opened generally radially outward, as best illustrated in FIG. 6. As the cord 24 is pulled outward toward an unwound state 42 (as best illustrated in FIG. 1) the recoil pulley 26 engages the crankshaft of the engine causing the piston(s) to reciprocate with sufficient speed to start the engine. When the cord 24 is released by the operator, the recoil spring (not shown) causes the pulley 26 to rotate clockwise through a series of complete revolutions. Because an opposite second end 44 of the cord 24 is engaged directly to the pulley 26, the cord 24 travels with the pulley and recoils back into the housing 30 (i.e. a recoiling state 46 as best illustrated in FIG. 2) until the handle 36 nestles or seats against the housing 30 proximate to the conduit 28, thus placing the recoil starter assembly 22 into the recoiled state 32, as best illustrated in FIG. 3.

The recoil starter assembly 22 interacts with the start assist device or carburetor 34 via a releasable or slip coupling 48 of the assembly 22 which connects to a choke valve 50 of the remotely located carburetor 34 by an elongated linkage 52, which is preferably a Bowden wire. The cord 24 has a plurality of windings, with a first winding 54 having the first cord end 38 connected directly to the handle 36 and a last winding 56 having the second end 44 connected to the pulley 26. Automatic positioning of the choke valve 50 to assist in starting the engine occurs generally during the first counter-clockwise rotation of the pulley 26 from the recoiled state 32, and thus during the withdrawal of the first winding 54 from the housing 30. This enables the remaining windings or revolutions of the pulley 26 to actually start the engine after the choke valve 50 and throttle valve of the carburetor 34 have been automatically positioned for optimum starting.

When the recoil starter assembly 22 is in the recoiled state 32, a shuttle 58 of the releasable coupling 48 is preferably generally centered in a circumferentially extending channel 60 defined radially between the housing 30 and a generally circular surface or pair of peripheral edges 62 of the pulley 26. The pulley groove 40 is defined laterally between the axially spaced edges 62 of the pulley 26.

During the initial pull of the cord 24 or during withdrawal of the first winding 54 from the housing 30, the shuttle 58 of the releasable coupling 48 moves counter-clockwise with the pulley 26 and within the channel 60 due to a frictional interface 61 engagement between the shuttle 58 and the pulley 26, and/or a torsional force (indicated by arrow 63) created by the orientation of the coupling 48 with the particular winding generally disposed within the housing 30 and adjacent the conduit 28. The shuttle 58 moves counter-clockwise until the shuttle 58 contacts a stop 64 carried by the housing 30 at which point the shuttle is in an actuated state 65. Upon contact, the shuttle 58 has moved a sufficient angular distance to actuate the start assist device or carburetor 34 via the linkage 52 which is connected to a radially projecting lever 66 of the shuttle 58 that extends through a slot 68 of the housing 30. With the shuttle 58 in the actuated state 65 or pressed against the stop 64, the remaining windings of the cord 24 are withdrawn from the housing 30 by the operator's continuing pull causing the pulley 26 to continue its rotation.

During this remaining or continuing pull, the frictional interface 61, formed by the contact between a radially inward concave face 70 of the shuttle 58 and the axially outward lying edge portions of the circular surface 62 of the pulley 26, is overcome by the pulling force exerted upon the cord 24 by the operator. Therefore, the pulley 26 continues to rotate counter-clockwise as the cord 24 is withdrawn from the housing 30 and as the coupling 48 remains stationary. The circumferential location of the stop 64 generally lies within the range of ninety to one hundred and twenty degrees away and in a clockwise direction from the conduit 28 which generally locates the channel 60 (i.e. coupling travel range) diametrically opposite the conduit 28. This generally diametrically opposed orientation assures that the releasable coupling 48 does not become bound or entangled proximate to the conduit 28 of the housing 30.

The frictional interface 61 between the surface 70 of the shuttle 58 and the surface 62 of the pulley 26 is induced or caused by a reactive force (identified as arrow 72) directed generally radially inward with respect to the pulley 26. Force 72 is produced by the looping of one of the windings of the plurality of windings of the cord 24 both over a roller 74 of the releasable coupling 48, supported rotatably by the shuttle, and the pulley 26. The roller 74 is disposed radially outward from the pulley 26 and is substantially centered axially with respect to the pulley over the groove 40. An alcove 76 of the shuttle 58 houses the roller 74 and opens radially inward so that any one winding of the cord 24 can be diverted from the groove 40 of the pulley 26, as it is routed over the roller 74 and then return back into the groove 40.

The contour or profile of the roller 74 forms a circular valley or V-groove 78 which axially centers the cord 24 to the roller 74. A rotational axis 80 of the roller 74 is orientated substantially parallel to a central axis 82 of the pulley 26. Pulling of the cord 24 by the operator creates a tension in the cord which biases the roller 74 and shuttle 58 radially inward against the pulley 26. This biasing force is represented by arrow 72. Because the cross section of the shuttle 58 is generally U-shaped and inverted, as illustrated in FIG. 6, the surface 70 has two parallel edge portions 84, 86 which frictionally contact the two respective rim portions 88, 90 of the surface 62 of the pulley 26. The cord windings which are contained within the housing 30 are therefore located within either the groove 40 of the pulley 26 or the alcove 76 of the shuttle 58.

When the recoil starter assembly 22 is in the recoiled state 32, as best shown in FIG. 3, the first winding 54 of the cord 24 is both wound about the pulley 26 and over the roller 74 of the shuttle 58 of the releasable coupling 48. During pulling of the cord 24, the tensile force produced is translated into the radial or normal force 72 and a tangential force or generally the torsional force 63. The normal force 72 causes the shuttle 58 to fictionally engage the radial surface 62 of the recoil pulley 26 and the tangential force 63 contributes toward the circumferential movement of the shuttle 58. Because the tangential force 63 generally overcomes any resistive biasing force of the start assist device 34, the shuttle 58 moves counter-clockwise with the pulley 26 until the shuttle 58 contacts the stop 64 carried by the housing 30. Upon contact, the operator must exert a sufficient amount of additional pulling force to generally overcome the frictional force 72 between the shuttle 58 and the pulley 26.

With continued pulling of the cord 24 the next successive winding which was generally wound a full three hundred and sixty degrees about the pulley 26, and not the roller 74, now enters the alcove 76 and travels over the roller 74, back down into the groove 40 of the pulley 26, and out of the conduit 28 to exit the housing 30. Each winding successively travels over the roller 74 as it leaves or exits the housing 30 until the last winding 56 comes to a rest over the roller 74, as best illustrated in FIG. 1 as the unwound state 42.

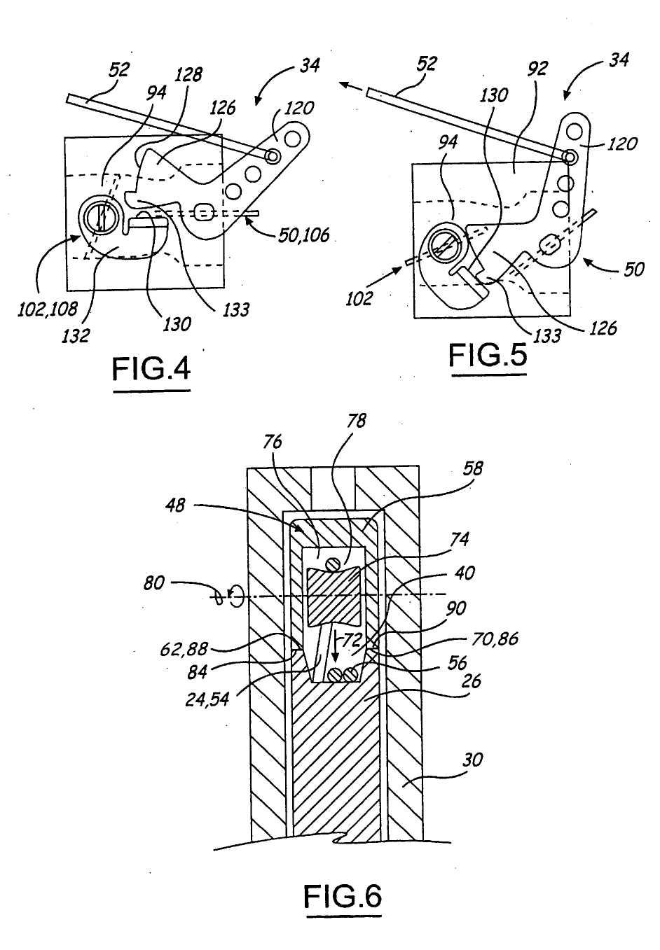

More specific to the carburetor 34, a body 92 carries a conventional fuel-and-air mixing passage 94 having a venturi region 96 disposed between an upstream region 98 and a downstream region 100. A butterfly-type throttle valve 102 operatively engages the butterfly-type choke valve 50 via a cam linkage 104. Both valves 50, 102 are engaged rotatably to the body 92 with the choke valve 50 disposed in the upstream region 98 and the throttle valve 102 disposed in the downstream region 100. Referring to FIG. 4, when the engine is either shut down or running at normal operating temperatures and idling speed, the choke valve 50 is biased into a full open position 106 and the throttle valve 102 is biased into an engine idle position 108 by respective torsional springs (not shown).

When the cord 24 of the recoil starter assembly 22 is initial pulled, the Bowden wire 52 moves for a distance pre-established by the location of the stop 64 of the housing 30 which is far enough to move the butterfly-type choke valve 50 from the spring biased full open position 106 to an actuation or closed position 110, as best illustrated in FIG. 1. This counter-clockwise rotation of the choke valve 50 causes engagement of the cam linkage 104 between the valves 50, 102 which rotates the throttle valve 102 clockwise against the biasing force of the throttle spring from the idle position 108 (as viewed in FIG. 4) and into an engine cold-start position 112 (as viewed in FIG. 1). When the cord is released, the clockwise rotation of the pulley 26 moves the releasable coupling 48 clockwise away from the stop 64 and toward a recoil stop 114 carried by the housing 30 and which defines the opposite end of the channel 60. The recoiling action of the pulley 26 causes the shuttle 58 to temporarily contact the recoil stop 114 creating a degree of slack within the Bowden wire 52 which can be taken-up by a slack retention device 116, as illustrated in FIG. 2.

This release of tension within the Bowden wire 52 also enables the biasing force of the choke spring to rotate the choke valve 50 clockwise from the closed position 110 (as viewed in FIG. 1) and into an engine warm-up or partial choke state 118 (as viewed in FIG. 2). During this rotation of the choke valve 50, the cam linkage 104 and the cam surface 128 slightly close the throttle valve 102, moving the throttle valve 102 from the cold-start position 112 to an engine warm-up or fast idle position 113, which decreases the richness of the fuel-and-air mixture delivered to the engine yet is still richer than normal running conditions. Further clockwise rotation of the choke valve 50 from the warm-up state 118 and into the open position 106 is prevented by a latch or tab 133 of the cam linkage 104. The cam linkage 104 is released when the operator manually actuates the throttle which causes the throttle valve 102 to rotate in an opening direction or clockwise against the bias of the throttle spring, thus releasing or clearing the choke valve 50 which moves to the full open position 106.

The Bowden wire or linkage 52 is engaged pivotally to a distal end of an arm 120 of the choke valve 50 which projects radially outward from an end of a rotating shaft 122 of the choke valve 50. The shaft 122 is rotatably engaged to the body 92 and traverses the upstream region 98 of the fuel and air mixing passage 94. Pivoting action of the arm 120 via pulling of the linkage 52 causes the shaft 122 to rotate and a plate 124 of the valve 50 disposed operatively in the passage 98 to pivot thus opening or closing the passage 98.

A radially projecting member 126 of the cam linkage 104 projects radially outward from the same end of the shaft 122 of the choke valve 50. The projecting member 126 has a cam surface 128 which contacts a contact face 130 of a lever 132 projecting radially outward from a rotating shaft 134 of the butterfly-type throttle valve 102. As the choke valve 50 rotates from the open position 106, which is preferably biased open by a torsional spring not shown, to the full closed position 110, the cam surface 128 of the cam linkage 104 carried by the choke valve 50 contacts the contact face 130 of the cam linkage 104 carried by the throttle valve 102, causing the throttle valve 102 to move from the biased engine idle position 108 (as best illustrated in FIG. 4) to the partially open or engine cold-start position 112. Consequently, whenever the cord or starter rope 24 is being pulled generally beyond the first winding 54, the choke valve 50 will be tightly closed and the throttle valve 102 will be in the cold-start position 112 unless the throttle is simultaneously actuated by the operator.

Alternatives to the cam linkage 104 can be incorporated into the carburetor 34. One such modification is the choke and throttle valve cam linkage taught in patent application Ser. No. 10/621,937, filed Jul. 17, 2003 and incorporated herein by reference.

Release of the cord 24 by the operator will cause the releasable coupling 48 to move clockwise with the spring-induced recoiling of the pulley 26, as best shown in FIG. 2. The torsional spring bias of the choke valve 50 causes the choke valve 50 to slip back or rotate clockwise to the partially open or warm-up state 118, as best shown in FIG. 2, which is pre-established by a tab 133 projecting radially outward from the cam surface 128. More specifically, as the choke valve 50 rotates clockwise from the closed position 110 to the warm-up state 118, due to the bias of the choke spring, the cam surface 128 carried by the choke valve 50 slides along the cam face 130 carried by the throttle valve 102, causing the throttle valve 102 to slightly close. This sliding action continues until the tab 133 is caught by or contacts the distal end of the lever 132, at which point the choke valve 50 is in the warm-up state 118 and the throttle valve is in the warm-up position 113. When the operator opens the throttle after the engine has sufficiently warmed-up, thus rotating the throttle valve 106 clockwise which moves the lever 132, the cam linkage 104 is released and the choke valve 50 rotates to the full open position 106 via the biasing force of the choke spring.

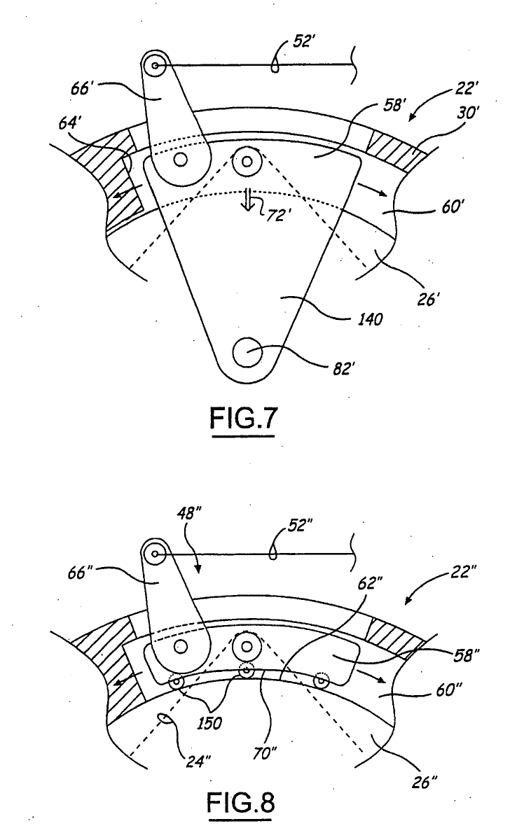

Referring to FIG. 7, a modification of the first embodiment is illustrated wherein the frictional interface 61 between the releasable coupling 48 and the pulley 26 is eliminated. Instead, the shuttle 58′, illustrated in FIG. 7, has a pair of generally pie shaped plates 140 which project radially inward on either side of a recoil pulley 26′ to rotatably attach to an axis or shaft 82′ of the pulley. The plates 140 radially space or hold the shuttle 58′ outward from the pulley 26′. With this arrangement, the shuttle 58′ moves circumferentially with respect to the shaft 82′ via generally a tangential force 63′ produced when pulling the cord 24′ or when the pulley 26′ is recoiling.

Referring to FIG. 8, a third modification of the present invention is illustrated wherein the friction produced between a surface 70″ of a shuttle 58″ and a surface 62″ of a pulley 26″ is reduced (relative to the frictional interface 61 of the first embodiment) by a series of wheels or roller bearings 150 disposed therebetween.

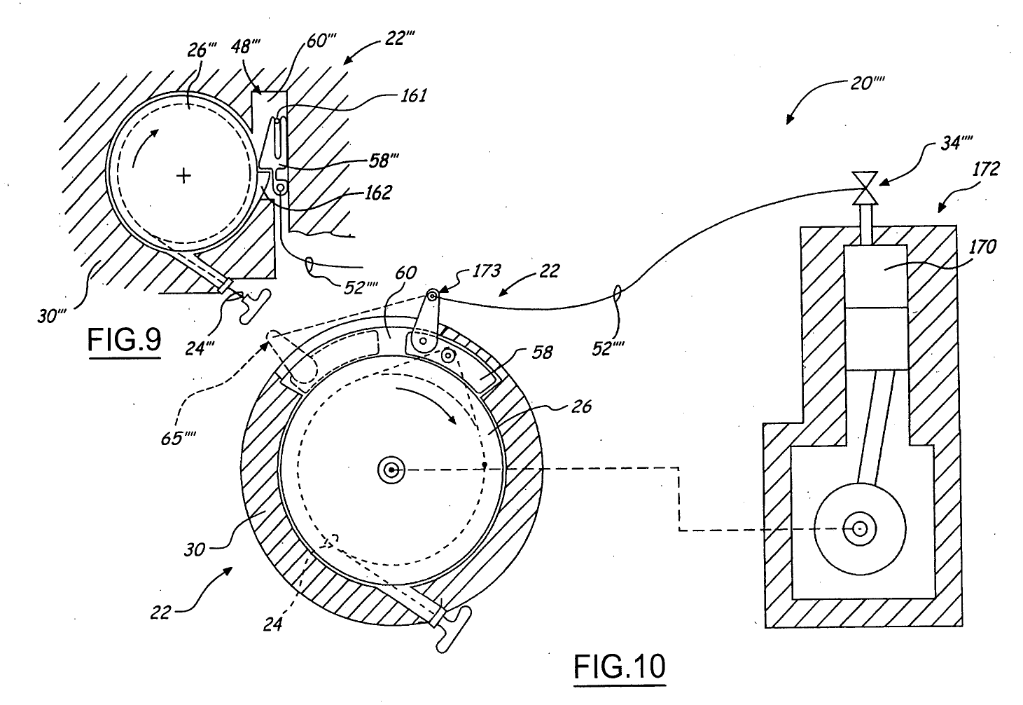

Referring to FIG. 9, yet a fourth modification of the present invention is illustrated wherein a releasable coupling 48′″ of a recoil starter assembly 22′″ has a fork shaped shuttle 58′″ which moves linearly and tangentially with respect to a recoil pulley 26′″ to pull upon a linkage 52′″ thereby actuating a start assist device (not shown). The linear movement of the shuttle 58′″ is guided by a channel 60′″ and a stationary pin 161 which projects generally laterally past and between the prongs of the fork shaped shuttle 58′″. With the initial pull of a pull-cord 24′″, the pulley 26′″ rotates counter-clockwise and a ramped projection 162 of the releasable coupling 48′″ which projects radially outward from the pulley 26′″ engages the forked shuttle 58′″ causing it to move linearly along the channel 60′″ carried by a housing 30′″ of the assembly 22′″. Once the shuttle 58′″ has moved and pulled upon the linkage 52′″ to actuate an external start assist device, it shall remain in the present position until the external start assist device return pulls upon the linkage 52′″.

Referring to FIG. 10, a fifth modification of a pull-cord start system 20′″ is illustrated wherein a start assist device 34′″ is actuated by the recoil starter assembly 22 (viewed in FIG. 1) having a releasable clutch coupling with a torsion spring as previously described. The start assist device 34′″, however, is not the carburetor of FIG. 1, but instead is a yieldably biased-closed, pressure relief valve which when opened, relieves any air pressure within a combustion chamber 170 of an engine 172. The valve 34′″ is yieldably biased closed and opens to relieve any air pressure trapped in the combustion chamber 170 when the shuttle 58 is moved to an actuation state 65 by the pulling of the cord 24 as previously described. Relieving this pressure upon the initial pull of the pull-cord 24 prevents any potential kick-back of the pull-cord 24 during starting of the engine. When the pull-cord 24 is released, the shuttle 58 moves out of the actuation state 65 and the valve 34′″ closes to its normally biased position. The engine starts when the torsion spring is sufficiently wound and releases to rotate the crankshaft.

While the forms of the invention herein disclosed constitute presently preferred embodiments, many others are possible. It is not intended herein to mention all the possible equivalent forms or ramifications of the invention. It is understood that terms used herein are merely descriptive, rather than limiting, and that various changes may be made without departing from the spirit or scope of the invention.

1. (canceled)

2. A pull-cord start system for a combustion engine comprising:
an engine start assist device;
a housing;
a recoil pulley disposed rotatably in the housing and connected to a crankshaft of the engine;
a releasable coupling disposed in-part in the housing and constructed and arranged to interact with the recoil pulley;
a linkage operably connecting the coupling with the start assist device;
a cord having a first and last winding wound about the recoil pulley, a first end adjacent the first winding for gripping by an operator, and a second end adjacent the last winding and engaged to the pulley;
wherein unwinding of the first winding by a manual pull of the cord by the operator causes the recoil pulley to rotate and the releasable coupling to move relative to the housing which actuates the start assist device;
a circumferential surface of the recoil pulley;
a groove of the recoil pulley opened radially outward for receiving the cord;
a channel defined radially between the housing and the circumferential surface; and
wherein the releasable coupling is disposed in part in the channel.

3. The pull-cord start system set forth in claim 2 wherein the start assist device is a carburetor having a choke valve and a throttle valve.

4. The pull-cord system set forth in claim 3 comprising:
the choke valve of the carburetor is connected to the linkage;
wherein the releasable coupling drives the linkage upon initial pulling of the cord which causes the choke valve to close and the choke valve closure to partially open the throttle valve.

5. The pull-cord start system set forth in claim 2 wherein the start assist device is a pressure relief valve which communicates with a combustion chamber of the engine.

6. The pull-cord start system set forth in claim 2 comprising:
the recoil pulley having a recoiled state, an unwound state and a central axis;
a shuttle of the releasable coupling disposed slidably in the channel; and
wherein the linkage is connected to the shuttle.

7. A pull-cord system for a combustion engine comprising:
an engine start assist device;
a housing;
a recoil pulley disposed rotatably in the housing and connected to a crankshaft of the engine;
a releasable coupling disposed in-part in the housing and constructed and arranged to interact with the recoil pulley;
a linkage operably connecting the coupling with the start assist device;
a cord having a first and last winding wound about the recoil pulley, a first end adjacent the first winding for gripping by an operator, and a second end adjacent the last winding and engaged to the pulley;
wherein unwinding of the first winding by a manual pull of the cord by the operator causes the recoil pulley to rotate and the releasable coupling to move relative to the housing which actuates the start assist device;
a circumferential surface of the recoil pulley;
a groove of the recoil pulley opened radially outward for receiving the cord;
a channel defined radially between the housing and the circumferential surface;
wherein the releasable coupling is disposed in part in the channel;
the recoil pulley having a recoiled state, an unwound state and a central axis;
a shuttle of the releasable coupling disposed slidably in the channel;
wherein the linkage is connected to the shuttle;
a roller of the coupling engaged rotatably to the shuttle within the channel, the roller having a rotational axis disposed parallel to the central axis and disposed radially outward of the recoil pulley;
wherein the first winding of the cord is wound over the roller and the recoil pulley and the last winding is wound only about the recoil pulley when the recoil pulley is in the recoiled state; and
wherein the first winding is withdrawn from the housing and the last winding is generally wound over the roller when the recoil pulley is in the unwound state.

8. The pull-cord start system set forth in claim 7 comprising:
a stop carried by the housing and defining a first end of the channel; and
wherein the shuttle contacts the stop as the cord is withdrawn from the housing.

9. The pull-cord start system set forth in claim 8 comprising:
a recoil stop carried by the housing and defining a second end of the channel; and
wherein the shuttle contacts the recoil stop as the pulley recoils and the cord rewinds back into the housing.

10. The pull-cord start system set forth in claim 9 comprising a radially inward facing surface of the shuttle being in releasable frictional engagement with the circumferential surface of the recoil pulley as the shuttle moves circumferentially between the pull and recoil stops.

11. The pull-cord start system set forth in claim 9 comprising a plurality of friction reducing wheels disposed between the shuttle and the recoil pulley.

12. The pull-cord start system set forth in claim 11 wherein the plurality of wheels are engaged rotatably to the shuttle and ride upon the circumferential surface of the pulley.

13. The pull-cord start system set forth in claim 9 comprising a plurality of bearings disposed between the shuttle and the recoil pulley.

14. The pull-cord start system set forth in claim 9 comprising:
a shaft disposed concentrically to the central axis;
a radially extending plate engaged to the shuttle and attached rotatably to the shaft; and
wherein the shuttle is spaced radially from the recoil pulley.

15. A pull-cord start system for a combustion engine comprising:
a start assist device having an actuated position and a normal operating yieldably biased position;
a housing;
a recoil pulley disposed rotatably in the housing and connected by a one way coupling to a crankshaft of the engine, the recoil pulley having a central axis, a yieldably biased recoiled state and an unwound state;
a shuttle in operable relationship with the recoil pulley, the shuttle having an actuation position;
a linkage operably connected to the shuttle and the start assist device;
a cord having a first and last winding wound about the recoil pulley, a first end adjacent the first winding for gripping by an operator, and a second end adjacent the last winding and engaged to the pulley;
a roller engaged rotatably to the shuttle about a rotational axis disposed parallel to the central axis of the recoil pulley;
the first winding of the cord is wound over the roller and the recoil pulley and generally encircles both the central axis and the rotational axis and the last winding is wound about only the recoil pulley so that the rotational axis is located radially outside of the last winding when the recoil pulley is in the recoiled state; and
the last winding of the cord is substantially wound over the roller and the recoil pulley and the first winding is disposed outside of the housing when the recoil pulley is in the unwound state.

16. The pull-cord start system set forth in claim 15 wherein unwinding of the first winding by a manual pull of the cord by the operator causes the recoil pulley to rotate and the shuttle to move into the actuation state which moves the start assist device into the actuation position via the linkage.

17. The pull-cord start system set forth in claim 16 wherein the shuttle remains in the actuation position as the cord is being pulled by the operator and when the recoil pulley is in the unwound state.

18. The pull-cord start system set forth in claim 2 wherein the start assist device comprises:
a carburetor having a fuel-and-air mixing passage;
a rotatable choke valve in the fuel-and-air mixing passage and yieldably biased to an open position;
a rotatable throttle valve in the fuel-and-air mixing passage downstream of the choke valve and yieldably biased to an idle position and away from a fast-idle position;
the linkage being operably connected to the choke valve to rotate the choke valve toward a closed position from the biased open position when the releasable coupling moves toward an actuated state upon pulling of the cord; and
release of the cord causes the releasable coupling to move out of the actuated state and the choke valve to automatically move at least partially toward the biased open position.

19. The pull-cord start system set forth in claim 18 wherein release of the cord causes the releasable coupling to move out of the actuated state and the choke valve to automatically move from the closed position to a partial choke state.

20. The pull-cord start system set forth in claim 18 further comprising a cam linkage of the carburetor connecting the choke valve to the throttle valve and constructed and arranged to prevent the choke valve from completely rotating into the biased open position and prevent the throttle valve from completely rotating into the biased idle position when the pull cord is released.

21. The pull-cord start system set forth in claim 20 further comprising:
a shaft of the choke valve extending laterally through the fuel-and-air mixing passage and rotatably carried by the body;
a member of the cam linkage projecting radially outward from the rotating shaft of the choke valve, the member carrying a cam surface;
a shaft of the throttle valve extending laterally through the fuel-and-air mixing passage and rotatably carried by the body;
a lever of the cam linkage projecting radially outward from the rotating shaft of the throttle valve, the lever carrying a contact face that contacts the cam surface;
a tab projecting radially outward from the cam surface wherein the tab contacts the lever as the choke valve automatically rotates from the closed position to a warm-up state when the cord is released;
an arm projecting radially outward from the shaft of the choke valve, the arm having a distal end connected to the linkage for rotation of the choke valve; and
wherein the throttle valve slightly closes automatically as the choke valve rotates from the closed position and at least partially toward the open position when the cord is released.

22. The pull-cord start system set forth in claim 21 wherein the throttle valve slightly closes automatically rotating from the cold-start position to a fast idle position as the choke valve rotates from the closed position to the warm-up state when the cord is released.

23. A pull-cord start system for a combustion engine comprising:
an engine start assist device;
a housing;
a recoil pulley disposed rotatably in the housing about a central axis and connected to a crankshaft of the engine;
a releasable shuttle disposed in-part in the housing and constructed and arranged to interact with the recoil pulley while moving circumferentially with respect to the central axis;
a linkage operably connecting the shuttle with the start assist device;
a cord having a first and last winding wound about the recoil pulley, a first end adjacent the first winding for gripping by an operator, and a second end adjacent the last winding and engaged to the pulley; and
wherein unwinding of the first winding by a manual pull of the cord by the operator causes the recoil pulley to rotate and the releasable shuttle to move relative to the housing which actuates the start assist device.

24. The pull-cord start system set forth in claim 23 further comprising:
a circumferential surface of the recoil pulley;
a groove of the recoil pulley opened radially outward for receiving the cord; and
a channel defined radially between the housing and the circumferential surface and substantially aligned axially to the groove and with respect to the central axis and the releasable coupling being disposed in part in the channel.

25. A pull cord start system for a combustion engine comprising:
a carburetor having: <a body,
a fuel-and-air mixing passage through the body,
a rotatable choke valve in the fuel-and-air mixing passage and biased yieldably in an open position, and
a rotatable throttle valve in the fuel-and-air mixing passage downstream of the choke valve and biased yieldably in a closing direction;
a pull-cord assembly having:
a housing,
a recoil pulley disposed rotatably in the housing and connected to a crankshaft of the engine,
a releasable coupling disposed at least in-part in the housing and constructed and arranged to interact with the recoil pulley, and
a cord having a first and last winding wound about the recoil pulley, a first end adjacent the first winding for gripping by an operator, and a second end adjacent the last winding and engaged to the pulley so that pulling of the cord causes the releasable coupling to move toward an actuated state; and
a linkage operably connecting the releasable coupling of the pull-cord assembly with the choke valve of the carburetor so that when the releasable coupling is moving toward the actuated state the linkage moves the choke valve toward a closed position from the biased open position, and release of the cord de-actuates the releasable coupling causing the choke valve to move partially toward the biased closed position.

26. The pull cord start system set forth in claim 25 further comprising a cam linkage of the carburetor connecting the choke valve to the throttle valve and constructed and arranged to prevent the choke valve from completely rotating into the biased open position and limiting biased rotation of the throttle valve toward a closing direction when the pull cord is released.

27. The pull cord start system set forth in claim 26 further comprising:
a shaft of the choke valve extending laterally through the fuel-and-air mixing passage and rotatably carried by the body;
a member of the cam linkage projecting radially outward from the shaft of the choke valve, the member carrying a cam surface;
a shaft of the throttle valve extending laterally through the fuel-and-air mixing passage and rotatably carried by the body; and
a lever of the cam linkage projecting radially outward from the shaft of the throttle valve, the lever carrying a contact face that contacts the cam surface.

28. The pull cord start system set forth in claim 27 further comprising a tab projecting radially outward from the cam surface wherein the tab contacts the lever as the biased open choke valve automatically rotates from the closed position to a warm-up state when the cord is released.

29. The pull cord start system set forth in claim 28 wherein the biased throttle valve slightly closes automatically rotating from a cold-start position to an engine warm-up position as the choke valve rotates from the closed position to the warm-up state when the cord is released.
